(19) United States
(12) Patent Application Publication
(10) Pub. No.: US 2015/0034777 A1
(43) Pub. Date: Feb. 5, 2015

(54) Paint Brush Holder

(71) Applicant: David Ionis, San Francisco, CA (US)

(72) Inventor: David Ionis, San Francisco, CA (US)

(21) Appl. No.: 13/959,503

(22) Filed: Aug. 5, 2013

(51) Int. Cl. B44D 3/12

(52) U.S. Cl. CPC B44D 3/123
USPC 248/113

(57) ABSTRACT

The paint brush holder is a device allowing the user to keep paint brush, when not in use, attracted by magnetic forces to a magnet and keeping brush bristles away from the device to prevent it from soiling and allowing the remaining paint drip back into the can. The paint brush holder includes a bracket with a magnet attached to an upper bended end of an upward bracket limb and a clamp for easy device fastening atop of the open paint can rim. The clamp consists of a lever pivotally attached to the horizontal limb of the bracket and a fastener attached pivotally to the lever. Additionally, in the clamp locked position an axis of the fastener rotation is located lower than axis of the lever rotation to keep the device reliably locked on the paint can rim.

### BACKGROUND OF INVENTION

1. Field of Invention

The present invention relates generally to accessories for painting, and more particularly to a paint brush holder, allowing the painter to keep paint brush during breaks above paint can opening.

2. Description of the Related Art

Painting is a time consuming process and even a discrete elements of a painting task are rarely completed without interruption: painters take breaks or attend to other work matters. Thus, there is always the question what to do with a wet paint brush. Typically painter will put the brush across the rim of the paint can or atop of the paint can lid. This is undesirable in that the handle of the brush becomes coated with paint and brush easily dislodged from the can causing paint to spill on the floor or other arias.

Prior arts trying to solve the problem described above are found in U.S. Pat. No. 3,729,158 to Nagy (1971) discloses a paint can brush holder mounted atop of the open paint can rim. This device need to be fasten or released by thumb screw that makes this process slow. Also the paint brush attracted to the paint can brush holder is in parallel position to the device that can lead to dripping of the remaining paint from brush bristles on the device.
Another U.S. Pat. No. 4,101,046 to Puntillo discloses a paint brush holder mounted atop of the open paint can rim without fastening. This device has the same problem as above by keeping paint brush parallel to the upward leg of the device and additionally covers a big portion of paint can opening for stability that makes difficult to access the paint with a large brush.

Thus, a paint brush holder solving the aforementioned problems is desired.

### SUMMARY OF THE INVENTION

The paint brush holder is a device attachable to the open paint can rim for holding the paint brush above paint level in the can by magnetic forces attracting a metal band of the paint brush and keeping paint brush bristles away from the device and allowing the remaining paint on the bristles drip back into the can.

Briefly, the concept herein revealed pertains to a paint brush positioning, elevating and holding device which is set forth as an attachment that is designed and adapted to be located and detachably clamped on the upper open rim-equipped end of the paint can.

It comprises a flat-faced metal or an equivalent L-shaped bracket, a magnet and a spring clamp. The magnet is attached to the bended upper end of the upward bracket leg and the horizontal limb of the bracket embodies an opening and a struck-down depending leg positioning and retaining tongue. The end of the horizontal leg is bent upon itself providing pivot support for the spring clamp. The spring clamp consists of a lever pivotally attached to the horizontal leg of the bracket and a spring attached pivotally to the lever. The spring is fashioned, preferably but not necessarily, into a curved shape. The free end of the spring is bent upon itself providing a hook.

To secure the paint brush holder on the paint can, it should be placed on the rim of the open paint can with the clamp lever in horizontal or upper position and retaining tongue of the bracket placed against the paint can and the spring with the hook released down inside the opening of the horizontal leg of the bracket.

These and other features of the present invention will become readily apparent upon further review of the following specifications and drawings.

### BRIEF DESCRIPTION OF THE DRAWINGS

FIG. 1 is a prospective view of a paint brush holder device according to the present invention showing a fragmentary portion of paint can A with the lid removed and the novel paint brush holder being fastened to the paint can rim. An upper end of an upward bracket leg with attached magnet is bended allowing paint brush B, having a metal band being attracted to the magnet by magnetic forces, stay above paint level in the paint can and keeping brush bristles away from the device and allowing remaining paint drip back into the can.

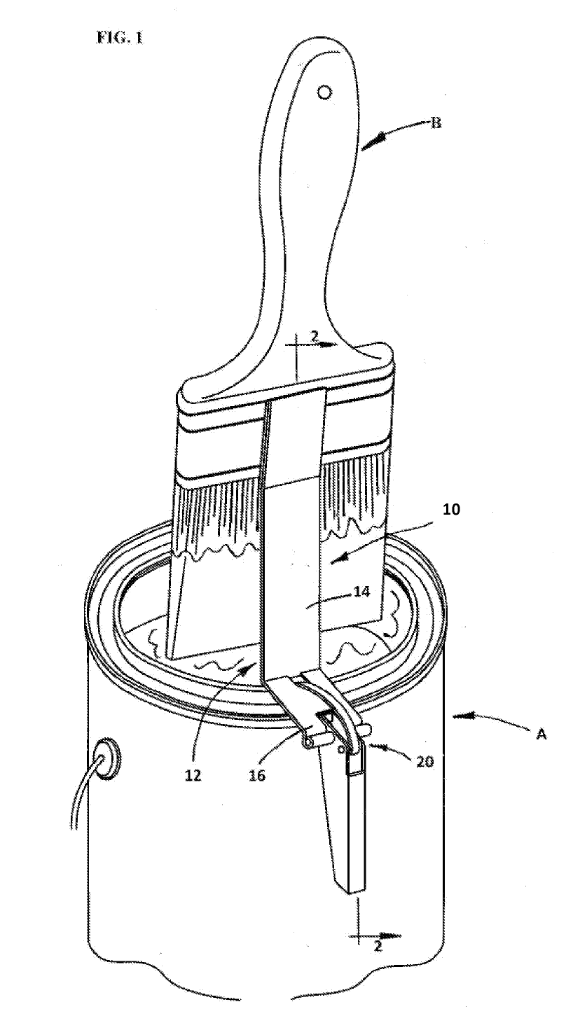

FIG. 2 is a central vertical sectional view with parts in elevation taken on the plane of the vertical section line 2-2 of FIG. 1 looking in the direction of the indicating arrows with paint brush holder attached to the paint can rim in locked position.

FIG. 3 is a central vertical sectional view as on FIG. 2 with paint brush holder in unlocked position and ready to be removed from the paint can rim.

Similar reference characters denote corresponding features consistently throughout the attached drawings.

### DETAIL DESCRIPTION OF THE INVENTION

Referring to FIG, 1, the paint brush holder 10 attached to the rim of the conventional paint can A for holding the conventional paint brush B supplied with usual metal band attracted to the magnet by magnetic forces above paint level in the paint can with brush bristles away from the device during breaks.

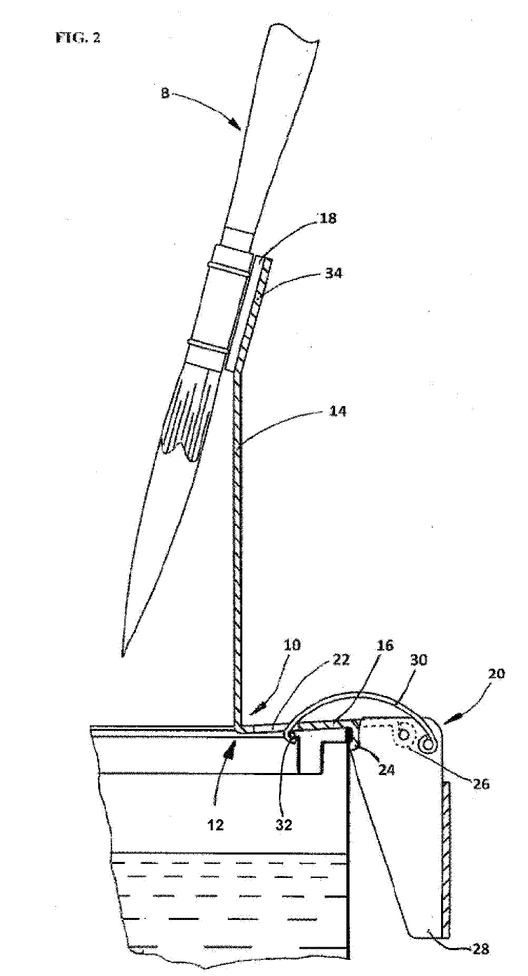

As best shown on FIG. 2 the paint brush holder 10 includes the L-shaped bracket 12 with upward limb 14 and horizontal limb 16, magnet 18 and spring clamp 20, it should be understood that magnet 18 is attached to the bended upper end 34 of the upward limb 14, the horizontal limb 16 has an opening 22, and struck-down retaining tongue 24. The horizontal limb 16 is bent at the end upon itself providing a pivot support 26 for the lever 28 of the spring clamp 20 with a spring 30 pivotally connected to the lever 28 and having a hook 32 at the free end.

As shown, axis of rotation of the spring 30 in locked position of the paint brush holder 10 being positioned lower than axis of rotation of the lever 28 to keep it reliably locked.

Additionally, it should be understood that the user places the paint brush holder 10 on the top of the open paint can rim with the retaining tongue 24 of the bracket 12 rested against an outside part of the rim and releases the spring 30 down into the opening 22 of the horizontal limb 16. The user than rotates the lever 28 all the way down allowing the hook 32 of the spring 30 to catch the inside ring of the paint can rim and secure the paint brush holder 10 on the top of the open paint can rim.

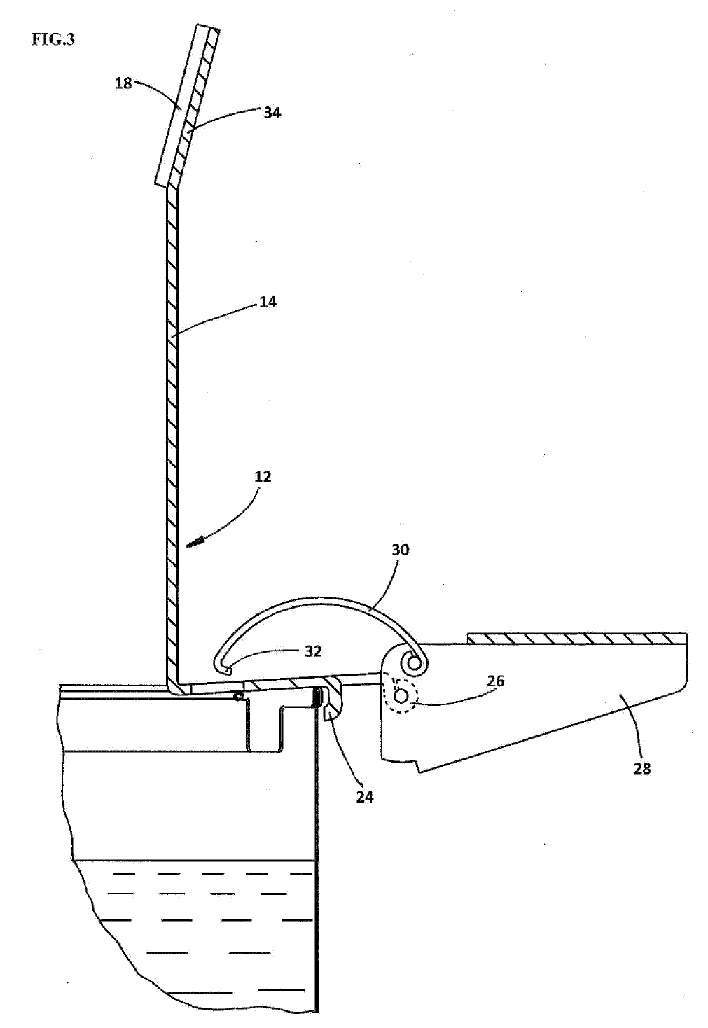

Father, as shown on FIG. 3 the lever 28 rotated up by user is releasing the spring 30 to unlock the paint brush holder 10 for removing it from the paint can.

It is to be understood that the present invention is not limited to the embodiments described above, but encompasses any and all embodiments within the scope of the following claims.

1. A paint brush holder, comprising:
a bracket with a magnet attached to the upper bended part of the upward limb of the bracket;
a clamp having a lever attached pivotally to the end of the horizontal limb of the bracket and fastener attached pivotally to the lever.

2. The paint brush holder as recited in claim 1 where an upper end of the upward limb is bent.

3. The paint brush holder as recited in claim 1 further comprising an opening and for the fastener in the horizontal limb;

4. The paint brush holder as recited in claim 1 further comprises a pivot support at the end of the horizontal limb of the bracket for the clamp;

5. The paint brush holder as recited in claim 1 wherein axis of rotation of the fastener being located lower than axis of rotation of the lever in clamp locked position on the paint can rim.

6. The paint brush holder as recited in claim 1 wherein the fastener comprises a hook on the free end.

7. The paint brush holder as recited in claim 1 wherein fastener has a curved shape.
